(19) United States
(12) Patent Application Publication
(10) Pub. No.: US 2014/0065366 A1
(43) Pub. Date: Mar. 6, 2014

(54) FORMED GLASS SHEETS WITH LOW SURFACE ROUGHNESS

(71) Applicant: Corning Incorporated, Corning, NY (US)

(72) Inventor: Laurent Joubaud, Paris (FR)

(73) Assignee: Corning Incorporated, Corning, NY (US)

(21) Appl. No.: 14/013,488

(22) Filed: Aug. 29, 2013

Related U.S. Application Data
(60) Provisional application No. 61/696,548, filed on Sep. 4, 2012.

(51) Int. Cl. C03B 23/023

(52) U.S. Cl. CPC C03B 23/023
USPC 428/141

(57) ABSTRACT

Formed glass sheets comprise a substantially flat portion and a curved portion extending from the flat portion. The flat portion and the curved portion each respectively define an outer surface and an inner surface with an average thickness between the respective outer and inner surfaces of from about 0.3 mm to about 2 mm. The surface roughness (Ra) of at least one of the respective outer and inner surfaces is less than or equal to about 0.5 nm.

### CROSS-REFERENCE TO RELATED APPLICATIONS

This application claims the benefit of priority under 35 U.S.C. §119 of U.S. Provisional Application Ser. No. 61/696,548 filed on Sep. 4, 2012, the content of which is relied upon and incorporated herein by reference in its entirety.

### TECHNICAL FIELD

The present invention relates generally to formed glass sheets and, more particularly, to formed glass sheets with low surface roughness.

### BACKGROUND

Conventional methods and apparatus are known to provide formed glass sheets with bent curved portions. There is a desire to provide formed articles with reduced surface roughness, particularly throughout a surface of a curved portion of the formed article.

### SUMMARY

The following presents a simplified summary of the disclosure in order to provide a basic understanding of some example aspects described in the detailed description.

In a first aspect, a formed glass sheet comprises a substantially flat portion and a curved portion extending from the flat portion. The flat portion and the curved portion each respectively define an outer surface and an inner surface with an average thickness between the respective outer and inner surfaces of from about 0.3 mm to about 2 mm. The surface roughness (Ra) of at least one of the respective outer and inner surfaces is less than or equal to about 0.5 nm.

In one example of the first aspect, the surface roughness (Ra) is less than or equal to about 0.3 nm.

In another example of the first aspect, the surface roughness (Ra) of at least one of the outer surface and inner surface of the curved portion is from about 0.1 nm to about 0.25 nm.

In still another example of the first aspect, the surface roughness (Ra) of at least one of the outer surface and inner surface of the curved portion is from about 0.1 nm to about 0.2 nm.

In yet another example of the first aspect, the surface roughness (Ra) of at least one of the outer surface and inner surface of the curved portion is about 0.15 nm.

In a further example of the first aspect, the surface roughness (Ra) of at least one of the outer surface and the inner surface of the flat portion is from about 0.1 nm to about 0.2 nm.

In another example of the first aspect, the surface roughness (Ra) of at least one of the outer surface and the inner surface of the flat portion is about 0.13 nm.

In still another example of the first aspect, edges of the curved portion pull away from a curve profile of a central area of the curved portion by less than or equal to about 0.2 mm from a plane of the flat portion.

In yet another example of the first aspect, the glass sheet comprises an ion-exchange strengthened glass sheet.

In a further example of the first aspect, at least one of the outer surface and the inner surface of the flat portion includes a flatness of less than or equal to 1 micron/mm.

In one example of the first aspect, an angle between an outer edge portion of the curved portion and the flat portion is at least about 45°.

In another example of the first aspect, an angle between an outer edge portion of the curved portion and the flat portion is at most about 180°.

Any examples of the first aspect may be used alone or in combination with any number of the other examples of the first aspect discussed above.

In a second aspect, an ion-exchange formed glass sheet comprises a substantially flat portion and a curved portion extending from the flat portion. The flat portion and the curved portion each respectively define an outer surface and an inner surface with an average thickness between the respective outer and inner surfaces of from about 0.3 mm to about 2 mm. At least the outer surface of the curved portion includes a surface roughness (Ra) of less than or equal to about 0.3 nm.

In one example of the second aspect, the surface roughness (Ra) is from about 0.1 nm to about 0.25 nm.

In another example of the second aspect, the surface roughness (Ra) is from about 0.1 nm to about 0.2 nm.

In still another example of the second aspect, the surface roughness (Ra) is about 0.15 nm.

In yet another example of the second aspect, at least one of the outer surface and the inner surface of the flat portion includes a flatness of less than or equal to 1 micron/mm.

In a further example of the second aspect, edges of the curved portion pull away from a curve profile of a central area of the curved portion by less than or equal to about 0.2 mm from a plane of the flat portion.

In still a further example of the second aspect, an angle between an outer edge portion of the curved portion and the flat portion is at least about 45°.

In yet a further example of the second aspect, an angle between an outer edge portion of the curved portion and the flat portion is at most about 180°.

Any examples of the second aspect may be used alone or in combination with any number of the other examples of the second aspect discussed above

### BRIEF DESCRIPTION OF THE DRAWINGS

These and other aspects are better understood when the following detailed description is read with reference to the accompanying drawings, in which:

FIG. 1 is perspective view of an example formed glass sheet in accordance with aspects of the disclosure;

FIG. 2 is a sectional view of the glass sheet along line 2-2 of FIG. 1;

FIG. 3 is an enlarged view of portions of FIG. 2; and

FIG. 4 a profile view of a curved portion of the formed glass sheet of FIG. 1.

### DETAILED DESCRIPTION

Examples will now be described more fully hereinafter with reference to the accompanying drawings in which example embodiments are shown. Whenever possible, the same reference numerals are used throughout the drawings to refer to the same or like parts. However, aspects may be embodied in many different forms and should not be construed as limited to the embodiments set forth herein.

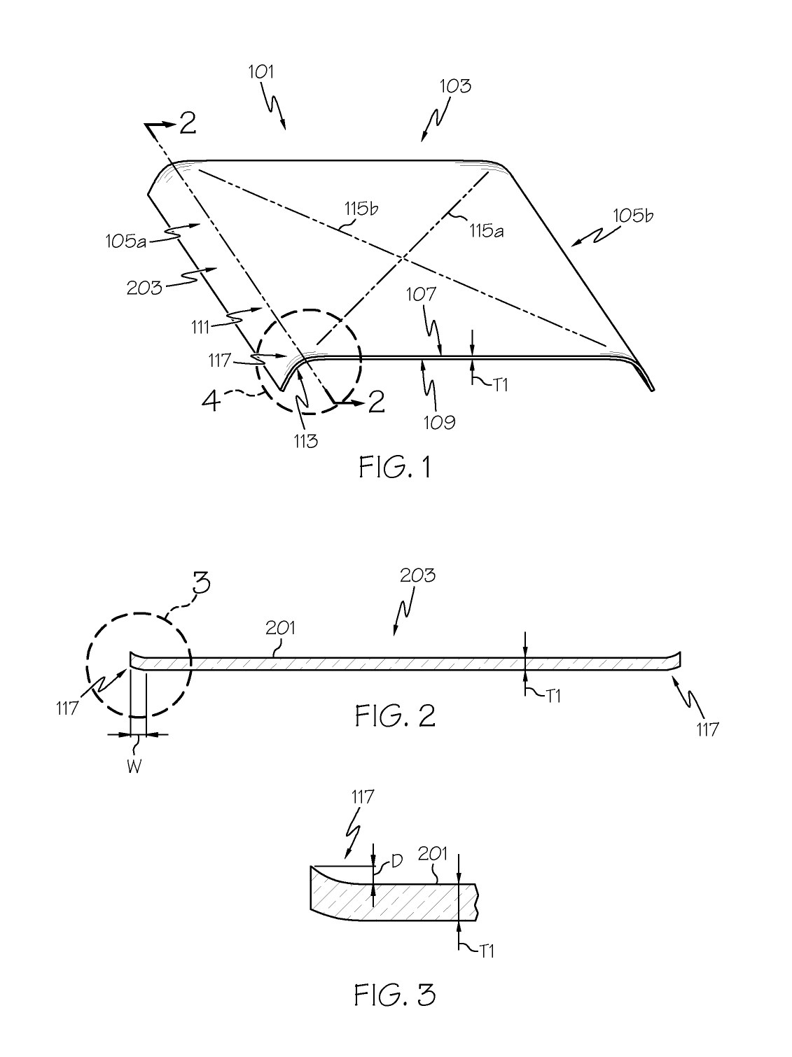

FIG. 1 illustrates a formed glass sheet 101 that maybe made in accordance with example method set forth in one or more of the following disclosures incorporated herein by reference: U.S. patent application Ser. Nos. 13/302,330; 13/303,685, 61/545,332; 61/545,329; 61/556,468; 61/657, 291 and EP 1229021.5.

The formed glass sheet 101 includes a substantially flat portion 103 and at least one curved portion 105a, 105b extending from the flat portion 103. In one example, a single curved portion may be provided although, as shown in FIG. 1, the formed glass sheet 101 can include a first curved portion 105a and a second curved portion 105b. In still further examples three or more sides (e.g., all of the sides) of the substantially flat portion 103 can include respective curved portions. For instance, as shown in FIG. 1, the flat portion 103 includes four sides with opposite sides including respective curved portions. In further examples an adjacent pair of sides may include curved portions. In further examples, three of the four sides may have curved portions. In still further examples, all four of the sides may include curved portions. In such examples, the curved portions may be separate from one another or joined together. For instance, adjacent curved portions may form a curved skirt extending down from the flat surface. In further examples, three or all four of the sides may be joined together as a skirt extending down from the substantially flat portion 103.

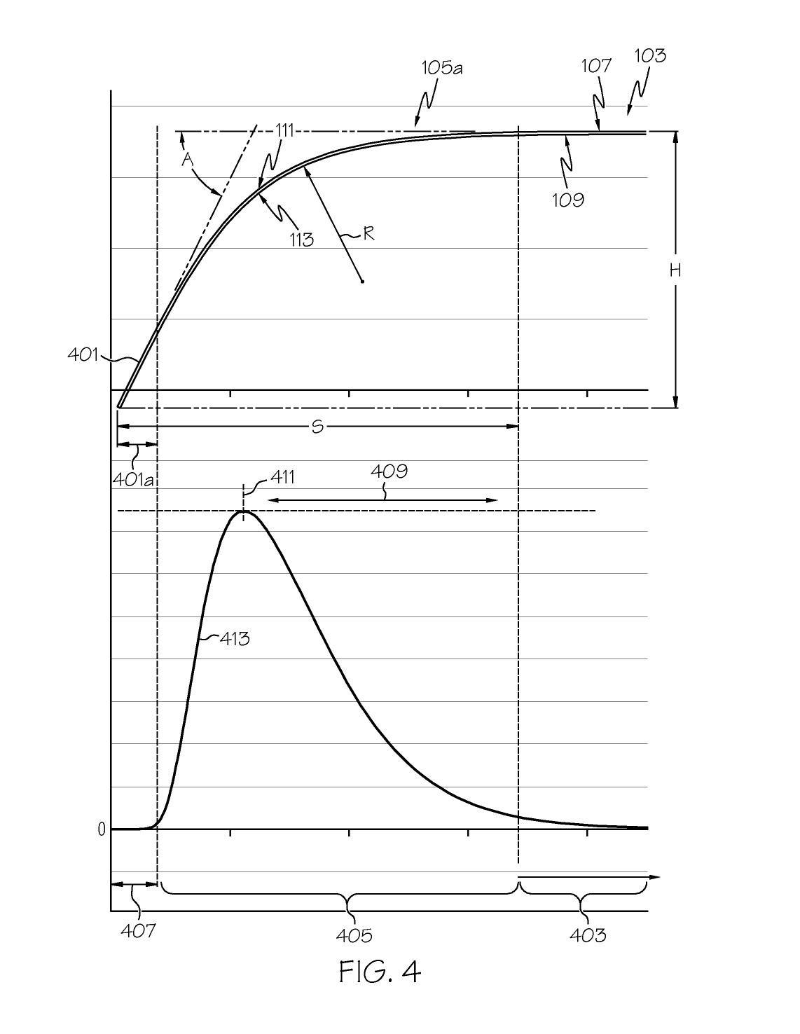

The flat portion 103 and the curved portion 105a, 105b each respectively define an outer surface and an inner surface. For example, as shown in FIGS. 1 and 4, the flat portion 103 includes an outer surface 107 and an inner surface 109. Likewise, the curved portions 105a, 105b can include an outer surface 111 and an inner surface 113.

As shown in FIG. 1, the average thickness T1 between the respective outer surfaces 107, 111 and inner surfaces 109, 113 of the flat portion 103 and/or the curved portions 105a, 105b is from about 0.3 mm to about 2 mm.

The arithmetic mean surface roughness (Ra) of at least one of the respective outer surfaces 107, 111 and inner surfaces 109, 113 is less than or equal to about 0.5 nm, such as less than or equal to about 0.3 nm. In one example, the surface roughness (Ra) of at least one of the outer surface 111 and inner surface 113 of the curved portion 105a, 105b is from about 0.1 nm to about 0.25 nm, such as from about 0.1 nm to about 0.2 nm, such as about 0.15 nm. In further examples, the surface roughness (Ra) of at least one of the outer surface 107 and the inner surface 109 of the flat portion 103 is from about 0.1 nm to about 0.2 nm, such as about 0.13 nm. Providing reduced surface roughnesses as discussed above can enhance optical clarity of the formed glass sheet. Moreover, the optical clarity can beneficially extend to the curved portions of the formed glass sheet to provide excellent clarity in the curved portions as well as the flat portion.

At least one of the outer surface 107 and the inner surface 109 of the flat portion 103 can comprise a flatness of less than or equal to 1 micron/mm. For example, both the outer surface 107 and the inner surface 109 of the flat portion can comprise a flatness of less than or equal to 1 micron/mm. In some examples, the flatness of 1 micron/mm can be observed along an axis 115a, 115b between opposed corners of the flat portion 103 although the flatness can be achieved along a wide range axis orientations.

As shown in FIG. 4, the curved portion 105a, 105b can include an outer edge portion 401 wherein an angle “A” between the outer edge portion 401 of the curved portion 105a and the flat portion 103 is at least about 45° . In further examples, the angle “A” is at most about 180°, such as from about 45° to about 120°, such as from about 45° to about 90°, such as from about 45° to about 60° although other angles may be provided in further examples.

In further examples, horn portions of the curved portion can be reduced, or even eliminated in further examples. For instance, edges 117 of the curved portion, in some examples, may undesirably pull away from a curve profile 201 of a central area 203 of the curved portion by a distance “D” of less than or equal to about 0.2 mm, such as less than or equal to about 0.1 mm, from a plane of the flat portion 103. Minimizing the horn portions can be beneficial to prevent lifting of corner portions of a cover glass from an underlying device at the corner portions. The width “W” of the horn portion can be relatively small relative to the overall width of the formed glass sheet.

In one example, the glass sheet can comprise an ion-exchanged strengthened glass sheet, such as Corning® Gorilla® Glass. Formed glass sheets of the present disclosure can have wide application in different fields. In one application, formed glass sheets of the present disclosure may be used to be associated with a display with touch functionality. In further examples, the formed glass sheet may find application as part of a display cover for an electronic display and/or a cover shield for an electronic device. Electronic devices can comprise touch screens, televisions, flat panel displays, mobile telephones or other devices. Such applications can be particularly useful when formed from ion-exchanged strengthened glass sheet that has particular scratch resistance and durability. Moreover, the substantially flat nature of flat portion 103 allows the flat portion to closely follow substantially flat display portions of a device to provide excellent transmission of light. Moreover, the curved portions can be designed to closely follow the formed edges of the device. The reduced horn effect helps prevent undesired lifting of the edges of the curved portion 201. Still further, the reduced surface roughness provides excellent optical clarity throughout the entire glass sheet within the flat portion 103 and throughout the curved portions 105a, 105b.

In some examples, the flat portion 103 can substantially seamlessly transfer from the flat portion 103 to the curved portions 105a, 105b. For instance, FIG. 4 illustrates curved portion 105a extending from a flat portion 103. The plot below the curved portion 105 designates the inverse of the level of curvature wherein 0 indicates a curvature of infinity designating a substantially flat surface. As shown, a display region 403 with a smooth curve evolution profile 405 extending from the display region 403 to an outer flat portion 407. As shown, a majority of the curve evolution occurs along the length 409 from the display region 403 until a maximum curvature is obtained at 411. The length 409 can shorter than about 10 mm such as shorter than about 5 mm although other lengths may be provided in further examples. Then the curvature quickly reduces along path 413 to the outer flat portion 407. The length of this region can be shorter than 10 mm or even shorter than 2 mm although other lengths may be provided in further examples.

Various curve portion dimensions maybe provided in accordance with aspects of the disclosure. For example, as shown in FIG. 4, the height “H” from the outer edge portion 401 and the flat portion 103 can be less than or equal to about 15 mm such as less than or equal to about 10 mm although other sizes may be provided in further examples. The size “S” of the nondisplay portions (405, 407) can be less than about 20 mm such as less than about 10 mm although other sizes may be provided in further examples. The length 401a of the outer edge portion 401 can be less than about 10 mm such as less than about 2 mm although other lengths may be provided in further examples. The local radius “R” of curvature, constantly changes as demonstrated by the evolution profile 405 and can be below 10 mm, below 5 mm or even below 4 mm in further examples.

Various aspects of the disclosure can provide a formed glass sheet with high scratch and impact resistance due to the optional ion-exchange strengthened nature of examples of the glass sheets. The seamless edges provide high mechanical resistance to impact, increased aesthetic of the device. The reduced surface roughness can provide excellent optical clarity even extending into the curved portions enabling a display or lighting capability in those curved portions.

It will be apparent to those skilled in the art that various modifications and variations can be made without departing from the spirit and scope of the claimed invention.

What is claimed is:

1. A formed glass sheet comprising:
a substantially flat portion and a curved portion extending from the flat portion, the flat portion and the curved portion each respectively define an outer surface and an inner surface with an average thickness between the respective outer and inner surfaces of from about 0.3 mm to about 2 mm, and the surface roughness (Ra) of at least one of the respective outer and inner surfaces is less than or equal to about 0.5 nm.

2. The formed glass sheet of claim 1, wherein the surface roughness (Ra) is less than or equal to about 0.3 nm.

3. The formed glass sheet of claim 1, wherein the surface roughness (Ra) of at least one of the outer surface and inner surface of the curved portion is from about 0.1 nm to about 0.25 nm.

4. The formed glass sheet of claim 3, wherein the surface roughness (Ra) of at least one of the outer surface and inner surface of the curved portion is from about 0.1 nm to about 0.2 nm.

5. The formed glass sheet of claim 4, wherein the surface roughness (Ra) of at least one of the outer surface and inner surface of the curved portion is about 0.15 nm.

6. The formed glass sheet of claim 1, wherein the surface roughness (Ra) of at least one of the outer surface and the inner surface of the flat portion is from about 0.1 nm to about 0.2 nm.

7. The formed glass sheet of claim 6, wherein the surface roughness (Ra) of at least one of the outer surface and the inner surface of the flat portion is about 0.13 nm.

8. The formed glass sheet of claim 1, wherein edges of the curved portion pull away from a curve profile of a central area of the curved portion by less than or equal to about 0.2 mm from a plane of the flat portion.

9. The formed glass sheet of claim 1, wherein the glass sheet comprises an ion-exchange strengthened glass sheet.

10. The formed glass sheet of claim 1, wherein at least one of the outer surface and the inner surface of the flat portion includes a flatness of less than or equal to 1 micron/mm.

11. The formed glass sheet of claim 1, wherein an angle between an outer edge portion of the curved portion and the flat portion is at least about 45°.

12. The formed glass sheet of claim 1, wherein an angle between an outer edge portion of the curved portion and the flat portion is at most about 180°.

13. An ion-exchange formed glass sheet comprising:
a substantially flat portion and a curved portion extending from the flat portion, the flat portion and the curved portion each respectively define an outer surface and an inner surface with an average thickness between the respective outer and inner surfaces of from about 0.3 mm to about 2 mm, and at least the outer surface of the curved portion includes a surface roughness (Ra) of less than or equal to about 0.3 nm.

14. The formed glass sheet of claim 13, wherein the surface roughness (Ra) is from about 0.1 nm to about 0.25 nm.

15. The formed glass sheet of claim 14, wherein the surface roughness (Ra) is from about 0.1 nm to about 0.2 nm.

16. The formed glass sheet of claim 15, wherein the surface roughness (Ra) is about 0.15 nm.

17. The formed glass sheet of claim 13, wherein at least one of the outer surface and the inner surface of the flat portion includes a flatness of less than or equal to 1 micron/mm.

18. The formed glass sheet of claim 13, wherein edges of the curved portion pull away from a curve profile of a central area of the curved portion by less than or equal to about 0.2 mm from a plane of the flat portion.

19. The formed glass sheet of claim 13, wherein an angle between an outer edge portion of the curved portion and the flat portion is at least about 45°.

20. The formed glass sheet of claim 13, wherein an angle between an outer edge portion of the curved portion and the flat portion is at most about 180°.
